(19) United States
(12) Patent Application Publication
(10) Pub. No.: US 2009/0324874 A1
(43) Pub. Date: Dec. 31, 2009

(54) PROCESS FOR THE PREPARATION OF A PANEL

(76) Inventors: Guido Jozefina Wihelmus G.J.W. Meijers, Stein (NL); Hubertus Marie Christine Stijnen, Dilsen-Stokkem (BE); Johannes Gerardus Hubertus Marie J.G.H.M. Housmans, Sint Joosterweg (NL)

Correspondence Address: NIXON & VANDERHYE, PC, 901 NORTH GLEBE ROAD, 11TH FLOOR, ARLINGTON, VA, 22203, US

(21) Appl. No.: 12/446,669

(22) PCT Filed: Nov. 5, 2007
(86) PCT No.: PCT/EP07/09560

§ 371 Date: May 13, 2009

Related U.S. Application Data
(60) Provisional application No. 60/857,804, filed on Nov. 9, 2006.

(30) Foreign Application Priority Data
Nov. 9, 2006 (EP) 06023325.1

(51) Int. Cl. B32B 7/12; B29C 35/08

(52) U.S. Cl. 428/98; 264/494; 425/174.4

(57) ABSTRACT

The present invention relates to a process for the preparation of a panel comprising a ligno-cellulose containing strand-like material, comprising the steps of treating the ligno-cellulose containing strand-like material with a combination of UV-radiation and ozone, either in-situ or ex-situ, mixing the resulting product with an adhesive composition, applying the resulting mix onto a press-bottom, and pressing and at least partially curing the composition to obtain a panel.

The invention relates to a process for the preparation of a panel, in particular a panel comprising ligno-cellulose fibres or strands.

Processes for the preparation of panels from strand-like material are known from for example WO 01/32375. In this process, the bonding of cereal straw in a panel is carried out with urea formaldehyde (UF) resin or melamine urea formaldehyde (MUF) resin in combination with an acid treatment of the straw. It is believed that this treatment alters or removes the wax or lipid layer that surrounds cereal straw. The treatment consists of applying either a strong or weak acid to straw. This results in a drop in straw pH and straw buffering capacity which facilitates the bonding of the straw with UF or MUF in a heated platen press.

The known process has as disadvantage that the treatment of the straw with an acid is rather cumbersome and expensive, and furthermore that the properties of the resulting panel are still unsatisfactory. It is known in the art that, when the acid treatment step is omitted, straw can only be effectively used in a panel in combination with an isocyanate resin. The use of such isocyanate resins for bonding the straw is expensive and special measures have to be taken to prevent the panels from sticking to the press.

It has been tried to use more economic resins to bond ligno-cellulose containing strand-like material such as straw into a panel board. Water-based resins have been tried for that purpose but resulted in very poor quality panels with low mechanical strength.

It is one of the objectives of the present invention to reduce or even eliminate the said disadvantages.

This objective is achieved in that the process comprises the step of treating the ligno-cellulose containing strand-like material with a combination of UV-radiation and ozone.

The invention may be characterised as follows. The invention relates to a process for the preparation of a panel comprising a ligno-cellulose containing strand-like material, comprising the following steps:
a) treating the ligno-cellulose containing strand-like material with a combination of UV-radiation and ozone, either in-situ or ex-situ
b) mixing the resulting product with an adhesive composition;
c) applying the resulting mix unto a press-bottom, and
d) pressing and at least partially curing the composition obtained in step c) to obtain a panel.

The invention also relates to a process according to claim 1 wherein the adhesive composition is a water-based resin.

The invention also relates to a process according to claim 2 wherein the water-based resin is selected from the group consisting of soybean, an aldehyde, and at least one component selected from the group consisting of urea, phenol and melamine, or mixtures thereof.

The invention also relates to a process according to claim 3 wherein the aldehyde is formaldehyde

The invention also relates to a process according to claim 1 wherein the adhesive composition is a non-water based resin.

The invention also relates to a process according to claim 5 wherein the non-water based resin is selected from the group consisting of soybean, polyvinyl acetates, epoxypolyester and acrylics.

The invention also relates to a process according to claims 1-6, wherein the curing temperature is between 275 and 525 K.

The invention also relates to a process according to anyone of claims 1-7, wherein the UV-radiation has a wavelength of between 1 and 385 nm, preferably below 310 nm, more preferable 254 nm.

The invention also relates to a process according to anyone of claims 1-8, wherein the UV-radiation has an intensity of between 0.1 and 725 mW/cm2 preferably between 1 and 60 mW/cm2 even more preferably between 10 and 50 mW/cm2

The invention also relates to a process according to anyone of claims 1-9, wherein the ligno-cellulose containing material is a non-wood agricultural material.

The invention also relates to a process according to anyone of claims 1-10, wherein the ligno-cellulose containing material has a water content up to full saturation.

The invention also relates to a process according to anyone of claims 1-11, wherein the ligno-cellulose containing material is natural straw.

The invention also relates to a process according to claims 1-12, wherein the adhesive composition is present in an amount of between 1 and 30 wt %.

The invention also relates to a process according to anyone of claims 1-13, wherein the adhesive composition is cured to at least 75%.

The invention also relates to a process according to anyone of claims 1-14, wherein the ligno-cellulose containing material is in the form of strands, which have been oriented prior to step d).

The invention also relates to a process according to anyone of claims 1-15, wherein the curing of the composition takes place at a temperature of between 350 and 450 K.

The invention also relates to a process according to anyone of claims 1-16, wherein the adhesive composition comprises and aldehyde and melamine.

The invention also relates to a process according to anyone of claims 1-17, wherein the aldehyde is formaldehyde.

The invention also relates to a panel, obtainable by a process according to anyone of claims 1-18.

The invention also relates to a panel according to claim 19, having the mechanical properties according to Canadian Standard CSA O437.0-93 Group 1 (R-1).

The invention also relates to an Oriented Strand Board, Medium Density Fiber Board, High Density Fiber Board, insulation board or Particle Board, obtainable by a process according to any one of claims 1-13.

The invention also relates to an apparatus suitable for performing the process according to claims 1-13.

One of the objectives of the invention is achieved in that a process is provided for the preparation of a panel that comprises the step of treating the ligno-cellulose containing strand-like material with a combination of UV-radiation and ozone.

The term fiber, strand or strand-like material is used interchangeably herein to indicate a material with the shape of a strand, i.e. having a greater length than width. Preferably, the length is 2, 3, 4, 8, 20, 50, 100 or even more times the width. An optimal strand length for a given combination of strand-like material and resin can easily be determined experimentally by the skilled person.

The term ligno-cellulose is used herein to indicate any of several closely related substances constituting the essential part of woody cell walls of plants and consisting of cellulose intimately associated with lignin. The term more in particular relates to the combination of lignin, hemicellulose and cellulose that forms the structural framework of plant cell walls. Ligno-cellulose is therefore the term used to refer to the bulk of plant material. It consists principally of lignin, cellulose, hemicellulose and extractives. Woody biomass is about 45-50% cellulose, 20-25% hemicellulose and 20-25% lignin.

The phrase ligno-cellulose containing strand-like material includes a strand mix comprising between 10 wt % and 100 wt % of non-wood agricultural strands. The term non-wood agricultural strands as used herein means strands from agriculturally grown plants or their harvested products/remnants, said plants reaching a harvest-stage of growth in two years or less. Such plants are as such widely known; examples of such plants or their harvested products include but are not limited to grass, straw, reed, (sugar) cane, bagasse, flax, hemp, kenaf, bamboo, cotton, cork, bark, sisal, and sorghum. As is known, the strands are typically not the entire original plant, but rather a part of it, typically the most fibrous part also know as rind. As is also known in the art, the strands may be obtained after some processing steps have been performed on the plants; said steps are not limited to but may include cutting, separating, and drying.

A particular embodiment of the invention relates to a process for the preparation of a panel comprising a ligno-cellulose containing strand-like material, comprising the following steps:
a) treating the ligno-cellulose containing strand-like material with a combination of UV-radiation and ozone,
b) mixing the resulting product with an adhesive composition;
c) applying the resulting mix onto a press-bottom, and
d) pressing and at least partially curing the composition obtained in step c) to obtain a panel.

This process may be applied with a wide variety of resins, in particular waterborne or water-based resins but also using non-water-based or waterborne materials. A particularly advantageous adhesive composition is a water based or waterborne resin. Examples of such resins include soybean as well as a composition comprising an aldehyde, and at least one component selected from the group consisting of urea, phenol and melamine, or mixtures thereof. A particularly suitable aldehyde may be formaldehyde.

The skilled person will be aware of the different ways available for curing a particular type of resin.

The adhesive composition may also be a non-water based composition. Examples of such compositions include soybean, polyvinyl acetates, epoxypolyester and acrylics.

The process according to the invention has the advantage that use is made of non-wood agricultural strands, such as straw. These types of strands are renewable on a more frequent basis than wood—e.g. every two years, annually or even more frequent. At the same time, a panel can be prepared that has good mechanical properties and is suitable for most, if not all applications where wood-based panels are currently used.

Within the context of this invention, the term panel is understood to mean a sheet that forms a distinct (usually flat) section or component of a material. Wood-based panels like chip board, MDF, Particle Board, or oriented strand board (OSB) are well known in the art. In a preferred embodiment of the invention, the method as described above relates to the preparation of a panel wherein the panel is an OSB.

The method according to the invention may be used for the preparation of a panel as described above, wherein the ligno-cellulose containing strand-like material comprises a mixture of different strands. This may mean that the ligno-cellulose containing strand-like material is heterogeneous with respect to source, length, strength, colour, stiffness or other relevant parameters. In particular, it may be derived from different sources, wherein straw is a preferred material. It is therefore possible that strands are used from more than one—e.g. 2, 3, 4 or even more—types of culture. Preferably, if there are strands from more than one origin, they are homogenously mixed.

The term straw is used herein to indicate the plant matter left over after the seeds are removed. More in particular, the term refers to the dry cut stalks of grain such as wheat, oats, rye, rice, barley etc. It may take the form of dried, hollow stems of grass plants with seed removed, usually left over after harvesting the plant material.

The strands suitable for making Oriented Strand Board (OSB) or Particle Board (PB) in the process according to the invention have a length of preferably at least 5 mm, this being the average length of the strands as measured on a sample of at about 500 grams. If the strands have a length of at least 5 mm, this contributes positively to the mechanical properties of the resulting panel. More preferably, the strands have an average length of at least 10, 15, 20, 25, 30, 40 or 50 mm. The upper value of the average length of the strands is primarily related to practical and origin-related constraints; thus, the said upper value can for example be up to 2000 mm, or preferably up to 1500, 1000, 750, 500, 400, 300, or 250 mm.

In a process for making MDF according to the invention, much smaller pieces of straw may be used. In fact, this type of board may be made using dust-size particles. The skilled person will be aware of optimal dimensions of the straw for the particular panel envisaged.

The thickness of the strands is, in particular for those of non-wood agricultural origin, primarily related to the thickness of the culture itself. It is sometimes preferred to use split strands such as straw, the average thickness will then be a significant fraction of the original thickness, e.g. one-fifth, or even a quarter, one-third, or half thereof or more. Aside from this, it is preferred in view of the desired properties of the end panel that the strands have an average thickness of at least 0.1 mm, more preferably at least 0.2, 0.3, 0.4 or even 0.5 mm or more.

Since it is an objective of the present invention to enhance the use of quickly-renewable resources, the strands in the strand mix as used in the invention should contain at least 10 wt. % of non-wood agricultural strands. Preferably, the mix contains at least 20, 30, 40, 50, 60, 70, 80, or even 90 wt % or more of said non-wood agricultural strands. It is even possible that essentially all of the strands in the strand mix have non-wood agricultural origin.

In a process according to the invention, a strand mix may be treated with UV radiation in the presence of ozone. It has been found that this treatment leads to improved properties of the panel, such as a higher strength and better internal bonding in comparison with non-UV/ozone treated straw, bonded together with water based resins. The treatment is thus effective to yield strand like material that can effectively be glued together using water-based resins. It has been established that the said combination of UV and ozone is effective even when low dosages of either UV or ozone are applied. It is also found that it is important to perform the UV radiation in the presence of ozone, since treatment with UV alone or with ozone alone does not result in sufficiently strong panels.

In order to apply the invention in an industrial setting, the strands may be placed on a conveyor belt in such a way that at least 5, 10 20 or 30 wt %, more preferably at least 40, 50, 60, or even at least 70 or 80 wt % of the strands are at least partly directly exposed to the UV radiation. It has been established that the strand-like material needs not to be directly “hit” by the UV radiation; it suffices when the strand-like material was contacted with the reaction products of ozone when exposed to UV irradiation.

Without wanting to be bound by theory, it is believed that UV irradiation of ozone leads to the formation of oxyl-radicals (ozoneolysis). Oxyl radicals are known in the art. It is believed that the contact of strand-like materials with oxyl-radicals renders the strand-like materials amenable to better adhesion of the water-based resins. Alternative processes yielding oxyl radicals are also believed to be applicable in the invention. In that case, the invention relates to a process for the preparation of a panel comprising a ligno-cellulose containing strand-like material, comprising the following steps:
a) treating the ligno-cellulose containing strand-like material oxyl radicals,
b) mixing the resulting product with an adhesive composition;
c) applying the resulting mix onto a press-bottom, and
d) pressing and at least partially curing the composition obtained in step c) to obtain a panel.

UV radiation is defined here as radiation in the wavelength between 1 and 380 nm. The wavelength of the UV irradiation is not critical; it is believed that every wavelength that is capable of inducing ozonolysis is in fact useful. Best results will be obtained with a UV source emitting a wavelength below 310 nm. In the below examples, a wavelength of 254 nm was used, giving very good results.

The amount of UV radiation as needed to achieve the benefits according to the invention will vary depending on relevant parameters such as the type of strand-like material. Upper and lower limits may be easily derivable by trial and error using a method for determining the shear strength between a straw and a reference material such as wood by using a water-based resin in a bond-strength assay as described in example 2.

Different types of UV sources are known in the art and may include conventional UV lamps or LEDs.

As indicated above, in the experimental set up as chosen in the examples provided herein, ozone should be present when the strands are exposed to UV radiation. Preferably, the concentration at and around the strands at the moment they are exposed to UV radiation is between 0.1 and 30 vol. %. Alternatively, the UV irradiation of the ozone could take place at a different location and the strand-like material is then contacted with the reaction products of the UV treated ozone. This is termed herein treatment in situ versus ex-situ.

Preferably, subsequent to the UV treatment in the presence of ozone, the strands are brought together with an adhesive composition. That may be done immediately or after some time. There were no effects measurable when the irradiated and ozone treated straw was stored for a period of up to several days or even weeks.

Water-based adhesive compositions as such are known. In the invention, it is preferred to use an adhesive composition comprising a resin composition, whereby said resin composition contains an aldehyde such as formaldehyde and at least one component selected from the group consisting of urea, soybean, phenol and melamine, or mixtures thereof.

Alternatively, non-water-based resins may be used in the process according to the invention. Such resins may be selected from the group consisting of natural binders such as soybean, polyvinyl acetates, epoxyesters and epoxyesters.

Within the context of the invention, the mentioning of aldehydes, urea, phenol and melamine refers to the compounds as such or in reacted form in resins or in adhesive compositions. Any molar ratios as given are for the accumulated amount, i.e. unreacted plus reacted compound.

As aldehyde in the resin composition, preferably formaldehyde is chosen. The term formaldehyde encompasses not only formaldehyde but also closely related compounds that can react as formaldehyde, such as paraformaldehyde and trioxan. Formaldehyde may be partly or wholly replaced by another aldehyde such as methylglyoxylate methanol hemiacetal or another alkanol hemiacetal as listed on page 3 of WO 03/101973.

In the resin composition, the aldehyde has at least partly reacted with at least one of the group consisting of urea, an aromatic hydroxyl compound, and melamine. The molar ratios between these compounds can vary within wide limits. In order to discuss these limits, it is customary that the amounts of the amino compounds urea and melamine can be recalculated into —(NH₂)₂ equivalents, as this enables a calculation wherein the amounts of urea and melamine are combined into one number. It is preferred that the molar ratio between the aldehyde and the sum of —(NH₂)₂ and the aromatic hydroxyl compound lies between 1:0.2 and 1:2; more preferably, the said ratio lies between 1:0.3 and 1:1.8, or between 1:0.4 and 1:1.7, or between 1:0.5 and 1:1.6, or even between 1:0.6 and 1: 1.5. When looking at the ratios between urea, melamine and the aromatic hydroxyl compound, it is noted that these ratios can vary in principle between all extremes, said extremes resulting in an melamine-aldehyde resin (urea and aromatic hydroxyl compound both essentially zero), an urea-aldehyde resin (melamine and aromatic hydroxyl compound both essentially zero), and an aromatic hydroxyl-aldehyde resin (melamine and urea both essentially zero).

The effect of the combined ozone/UV treatment was measured in an experimental set-up. As detailed in example 1, straw was treated with UV and ozone between 2 and 90 minutes with a variable dose of UV light and under different ozone concentrations. Intensity of UV irradiation was between 30 and 36 mW/cm².

Straw thus treated was analysed for its ability to yield stronger panels. Therefore a model system was developed as detailed in Example 2. Therein the shear strength is measured of a straw glued to a wooden strip using a water-based resin.

The results (Table 1) show that there is a remarkable relationship between the ozone consumption of the process and the shear force that a piece of straw can withstand before the resin bond breaks.

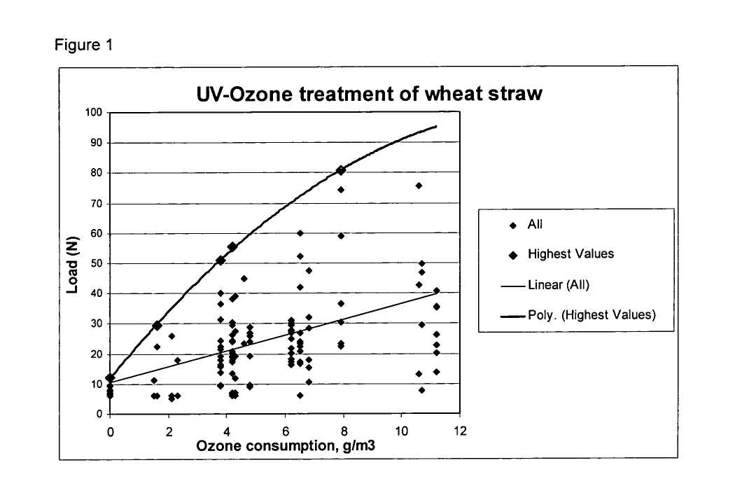

As shown in FIG. 1, the shear strength obtained with untreated straw was in the order of 10 N. The straws that were treated in a way that resulted in a moderate ozone consumption of about 2 g/m³ already showed a maximum load of 30 N. It was possible to treat the straw in such a way that it could withstand forces up to 80 N. Also, the average load increased with ozone consumption in the experimental set-up (FIG. 1).

It has to be mentioned here that not all data points in FIG. 1 represent the actual strength of the resin bond. Some straws broke even before the glued bond collapsed. These measurements were interpreted as representing the minimum strength of the bond. Where the bond broke, this was interpreted as its maximum strength. Remarkably, In 11 out of 12 (92%) of the control experiments listed in table 1, the resin bond broke before the straw, indicating that the resin bond was much weaker than the straw itself. In contrast therewith, from the 112 straws listed in table 1 that were treated with UV and ozone, only 13 (12%) showed a break in the resin bond, whereas in all other cases, the straw broke before the resin bond collapsed. That means that the strength of the resin bond in this case exceeded the strength of the straw, and thus yielded the straw suitable for use in a panel board. The strength of such an improved board would then only be determined by the strength of the particular kind of straw used for its production and not by the resin used.

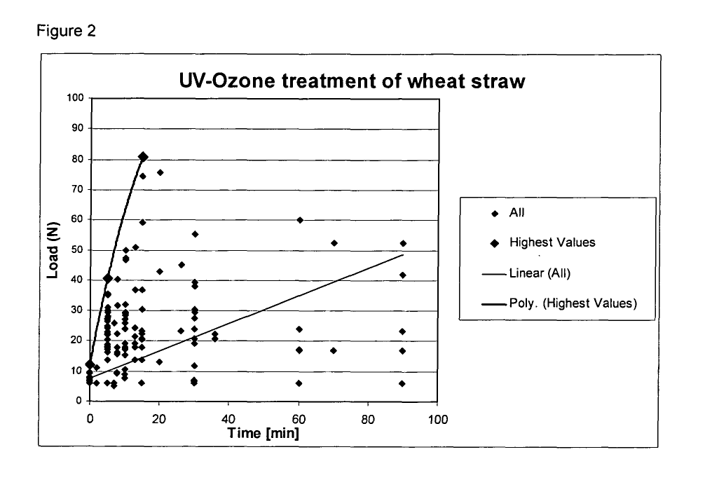

It is also evident from the results shown in table 1 that the effect is almost instantaneously. FIG. 2 shows the effects obtained in relation to the time of treatment. The maximum effect of 80 N was reached after 15 minutes of treatment whereas good results of more than 40 N could be achieved after 2 minutes of treatment only.

Temperatures in these experiments varied between 20° C. and 80° C. with some exceptional peaks above that. No effects of temperature of any statistical relevance could be established, however, some experiments showed that a more effective treatment was achieved at elevated temperatures, such as for instance above 40° C., 60° C. or even above 80° C.

Remarkably, it was found that straw needed not to be directly irradiated by the UV source; even when the layer of straw in the experimental set-up was about 6-7 centimetres thick, the straws at the bottom of the stack were as good as the straws on top, directly irradiated by the UV source. It is therefore postulated that the effect is caused by very reactive oxyl radicals produced by the UV irradiation of the ozone, rather than a direct effect of UV irradiation of the straw. This would also explain why the effect is not observed in untreated straw that has been on the field in weather conditions with somewhat elevated ozone concentrations, such as sometimes found after thunderstorms, irradiated by UV from natural sunlight.

When straw treated with any of the experimentally applied conditions was used for the fabrication of panel boards, it was observed that any of the experimentally applied conditions was sufficient to yield better quality panel boards. This shows the validity of the experimental model as well as the industrial applicability of the present invention. It will be appreciated that the conditions for applying the method according to the invention may vary over different ranges. It is now within the reach of the skilled person to determine the exact parameters under which improved straw panels may be produced. It is envisaged that a suitable process for producing UV/ozone treated straw uses a conveyor belt that runs through an ozone containing chamber where it is irradiated with UV. Alternatively, the UV irradiation of ozone may take place in a separate compartment and the reaction products of the ozonolysis process may be fed into a chamber where the straw passes with a suitable speed. The equipment as described in example 2 may provide a useful tool to quickly determine whether a particular combination of features is effective in delivering the envisaged result.

It will also be understood that the process according to the invention may be useful for the production of all kinds of panels that require a superior mechanical strength. Such panels may include Oriented Strand Board, Medium Density Fiber Board, High Density Fiber Board, insulation board or Particle Board. The skilled person is aware of the meets and bounds of those types of boards

In the way as described above, straw could be obtained that resulted in panel boards that had the mechanical properties according to Canadian Standard CSA 0437.0-93 Group1 (R-1)

FIG. 1: Relation between the ozone consumption and shear strength, indicated as Load, in Newton

FIG. 2: Relation between the time of treatment and shear strength, indicated as Load, in Newton

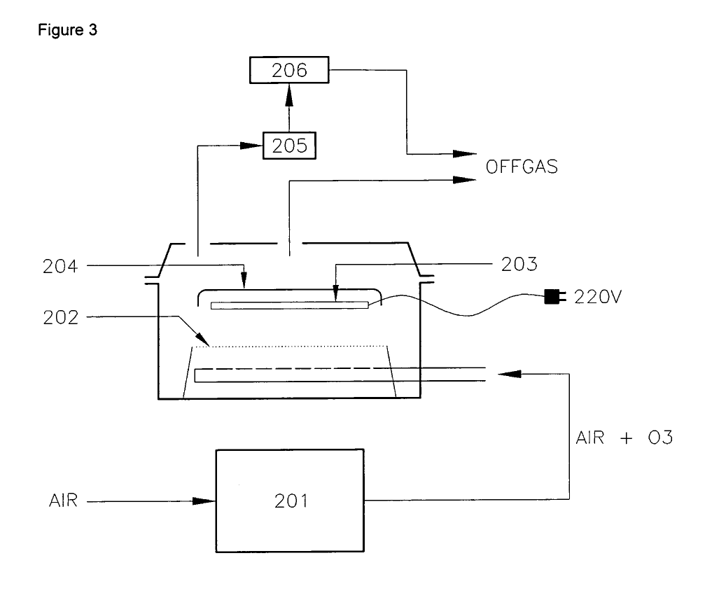

FIG. 3: Schematic representation of an experimental setup used for the combined UV/ozone treatment. Reference signs indicate: 201: ozone generater, 202: grid, 203: UV lamps, 204: reflectors, 205: Sample pump, 206 ozone meter

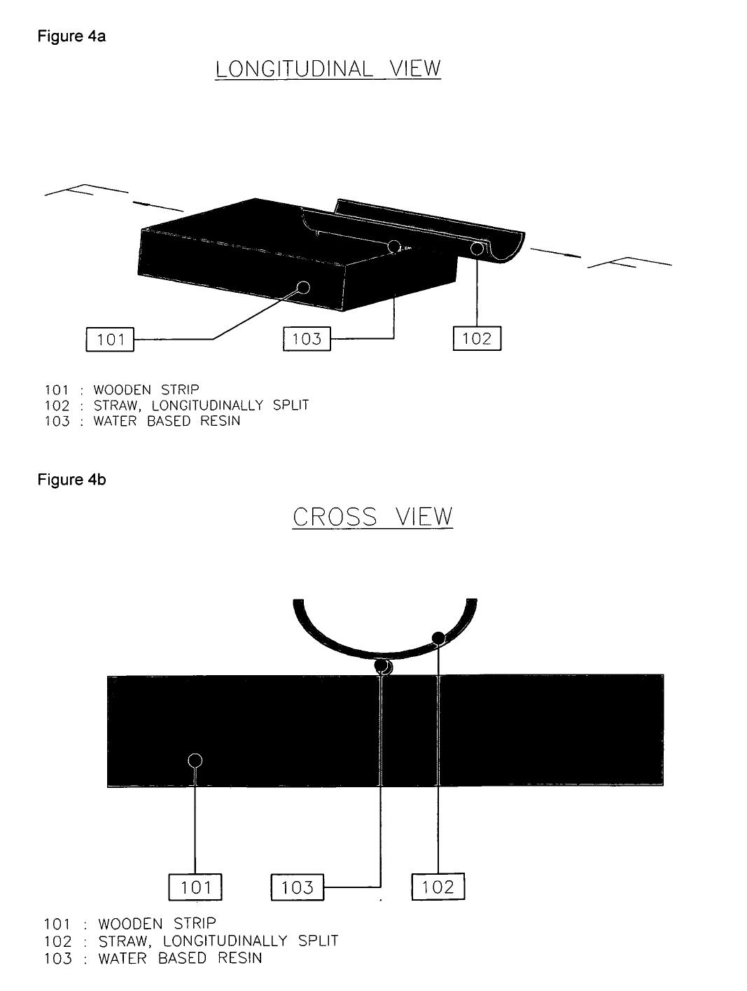

FIG. 4. Schematic representation of an experimental setup for determining the shear strength of a resin bond. FIG. 4a Longitudinal view, FIG. 4b cross-sectional view. 101: wooden strip, 102: straw, 103; resin bond. The character F indicates the force in the direction of the arrow.

### EXAMPLE 1

### Experimental UV/Ozone Treatment

A grid was positioned in a closed box of approximately 5 centimetres above the bottom of the box (FIG. 3). The experiments were performed in two differently sized boxes, one having approximate dimensions of 50×30×40 cm (b×h×w), the other one of 100×30×25 cm (b×h×w). Pieces of straw split in the longitudinal direction essentially as described in European Patent EP 0998379B1 to Alberta Research Council, the individual straws having approximate dimensions of 0.5-25 cm length and a thickness determined by the natural source, were positioned on top of the grid. A UV source was movably positioned above the grid, such that it could be used at variable distances above the grid. An ozone inlet was positioned below the grid in such a way that the ozone could flow freely and evenly distributed through the grid, along the straw, towards an ozone outlet at the top of the box. Ozone was generated using a commercially available ozone generater. Ozone flow was measured at inlet and outlet in order to determine the level of ozone consumption by the process. Ozone flow was adjusted at the inlet to a predetermined level (Table 1) and the flow was measure at the inlet. When the ozone flow at the inlet reached a constant level, the UV lights were switched on and ozone consumption was measured by determining the difference between ozone concentration at inlet and outlet. Special care was taken to ensure that enough ozone was available for the reaction. In practice this was done by ensuring that there was still ozone coming out of the outlet. Different types of UV lamps were used; low pressure and medium pressure lamps indicated in table 1 as LP and MP.

### EXAMPLE 2

### Measuring of Shear Strength

Straw treated in the way described in example 1 was recovered from the grid and glued to a wooden strip. Special care was taken to glue only the outside of the straw to the wooden strip since it is known that the inside provides a better bond with water-based resin than the outside (FIG. 4). This effect is sometimes explained by the fact that the outside of straw contains a waxy or lipid layer whereas the inside does not. The water based resin used for gluing the straw to the wooden strip consisted of commercially available Melamin Urea Formaldehyde (MUF resin Hexion BR62WT)). The glue was cured for about 1 minute at 140° C. and the wooden strip with the straw attached (construct) was then applied to an apparatus that measured the shear strength of the construct. The maximum load was determined in that an increasing force was applied in the longitudinal direction of the construct. It was noted whether the straw broke or whether the bond collapsed (Table 1).

### EXAMPLE 3

### Construction of Panel Boards

One to 14 cm long pieces of split cereal straw was treated for 30 minutes with UV and ozone, essentially as described in example 1. Four low pressure UV lamps were used with a wavelength of 254 nm and a combined power of 4000 Watt. This resulted in a dose of approximately 7 mW/cm2. Average distance from UV source to straw was approximately 25 cm with a range of 5-45 cm. Ozone consumption was approximately 20 g/m3. A commercially available MUF resin (Hexion BR62WT) containing ammonium sulphate as a catalyst was sprayed onto the straw using an atomiser in an amount of 8-10 dry wt %. A mat of dimensions 865×865 mm was constructed by hand and pressed at 190° C. at a controlled pressure of 1700 KPa during 160-200 seconds. The panels were pressed to the target thickness of 11.1 mm.

After pressing, the panels were trimmed to dimensions of 711×711×11.1 mm. The target density was 640 kg/m3; the various plates obtained according to the above procedure showed densities ranging from 628 to 678 g/m3.

### EXAMPLE 4

### Performance of OSB Made from UV/Ozone Treated Straw

Two separate panels produced according to example 3 were tested for their strength according to Canadian Standard CSA O437/Group 1 (R-1). A prior art board was constructed in exactly the same way as described in example 3, without the UV/ozone treatment and is shown for comparative purposes. Modus of elasticity (MOE) and Modus of rupture (MOR) of the panels according to the invention were measured in this experiment as well as the internal bond strength of the panels. The results are shown in Table 2

TABLE 1

| Time of | | | | | | | | | |
|---|---|---|---|---|---|---|---|---|---|
| Ozone/UV | Distance | | Wavelength | UV | | Ozone | Ozone | Ozone | Shear |
| treatment | UV/straw | Type of | Of UV | Dose | UV dose | conc in | conc out | consumption | force |
| [min] | [cm] | UV lamp | [nm] | [W] | [mW/cm2] | [g/m3] | [g/m3] | [g/m3] | [N] |
| CONTROLS | | | | | | | | | |
| 0 | NA | NA | NA | 0 | 0 | 0 | 0 | 0 | 8.1 |
| 0 | NA | NA | NA | 0 | 0 | 0 | 0 | 0 | 9.2 |
| 0 | NA | NA | NA | 0 | 0 | 0 | 0 | 0 | 12.2 |
| 0 | NA | NA | NA | 0 | 0 | 0 | 0 | 0 | 6.1 |
| 0 | NA | NA | NA | 0 | 0 | 0 | 0 | 0 | 7.1 |
| 0 | NA | NA | NA | 0 | 0 | 0 | 0 | 0 | 7.1 |
| 0 | NA | NA | NA | 0 | 0 | 0 | 0 | 0 | 9.6 |
| 0 | NA | NA | NA | 0 | 0 | 0 | 0 | 0 | 7.1 |
| 0 | NA | NA | NA | 0 | 0 | 0 | 0 | 0 | 7.6 |
| 0 | NA | NA | NA | 0 | 0 | 0 | 0 | 0 | 6.6 |
| 0 | NA | NA | NA | 0 | 0 | 0 | 0 | 0 | 6.6 |
| 0 | NA | NA | NA | 0 | 0 | 0 | 0 | 0 | 6.1 |
| EXAMPLES | | | | | | | | | |
| 2 | 5.5 | LP | 254 | 120 | ND | 7 | 6 | 2 | 11 |
| 5 | 5.5 | LP | 254 | 120 | ND | 6 | 4 | 2 | 6 |
| 5 | 5.5 | LP | 254 | 120 | ND | 6 | 4 | 2 | 30 |
| 7 | 5.5 | LP | 254 | 120 | ND | 7 | 5 | 2 | 5 |
| 7 | 5.5 | LP | 254 | 120 | ND | 7 | 5 | 2 | 6 |
| 15 | 5.5 | LP | 254 | 120 | ND | 7 | 4 | 2 | 18 |
| 26 | 5.5 | LP | 254 | 120 | ND | 7 | 2 | 5 | 23 |
| 36 | 5.5 | LP | 254 | 120 | ND | 9 | 3 | 7 | 21 |
| 60 | 5.5 | LP | 254 | 120 | ND | 9 | 3 | 7 | 60 |
| 60 | 5.5 | LP | 254 | 120 | ND | 9 | 3 | 7 | 17 |
| 60 | 5.5 | LP | 254 | 120 | ND | 9 | 3 | 7 | 6 |
| 60 | 5.5 | LP | 254 | 120 | ND | 9 | 3 | 7 | 17 |
| 90 | 5.5 | LP | 254 | 120 | ND | 9 | 3 | 7 | 23 |
| 2 | 5.5 | LP | 254 | 120 | ND | 7 | 6 | 2 | 6 |
| 5 | 5.5 | LP | 254 | 120 | ND | 6 | 4 | 2 | 22 |
| 7 | 5.5 | LP | 254 | 120 | ND | 7 | 5 | 2 | 26 |
| 15 | 5.5 | LP | 254 | 120 | ND | 7 | 4 | 2 | 6 |
| 26 | 5.5 | LP | 254 | 120 | ND | 7 | 2 | 5 | 45 |
| 36 | 5.5 | LP | 254 | 120 | ND | 9 | 3 | 7 | 22 |
| 60 | 5.5 | LP | 254 | 120 | ND | 9 | 3 | 7 | 24 |
| 70 | 5.5 | LP | 254 | 120 | ND | 9 | 3 | 7 | 17 |
| 70 | 5.5 | LP | 254 | 120 | ND | 9 | 3 | 7 | 52 |
| 90 | 5.5 | LP | 254 | 120 | ND | 9 | 3 | 7 | 6 |
| 90 | 5.5 | LP | 254 | 120 | ND | 9 | 3 | 7 | 42 |
| 90 | 5.5 | LP | 254 | 120 | ND | 9 | 3 | 7 | 17 |
| 90 | 5.5 | LP | 254 | 120 | ND | 9 | 3 | 7 | 52 |
| 5 | 20 | MP | . . . | 1000 | 30 | 20 | 9 | 11 | 14 |
| 5 | 20 | MP | . . . | 1000 | 30 | 20 | 9 | 11 | 26 |
| 5 | 20 | MP | . . . | 1000 | 30 | 20 | 9 | 11 | 23 |
| 5 | 20 | MP | . . . | 1000 | 30 | 20 | 9 | 11 | 41 |
| 5 | 20 | MP | . . . | 1000 | 30 | 20 | 9 | 11 | 35 |
| 5 | 20 | MP | . . . | 1000 | 30 | 20 | 9 | 11 | 20 |
| 5 | 20 | MP | . . . | 1000 | 30 | 20 | 9 | 11 | 36 |
| 10 | 20 | MP | . . . | 1000 | 30 | 20 | 9 | 11 | 47 |
| 10 | 20 | MP | . . . | 1000 | 30 | 20 | 9 | 11 | 30 |
| 10 | 20 | MP | . . . | 1000 | 30 | 20 | 9 | 11 | 8 |
| 10 | 20 | MP | . . . | 1000 | 30 | 20 | 9 | 11 | 50 |
| 15 | 20 | MP | . . . | 1000 | 31 | 17 | 9 | 8 | 23 |
| 15 | 20 | MP | . . . | 1000 | 31 | 17 | 9 | 8 | 59 |
| 15 | 20 | MP | . . . | 1000 | 31 | 17 | 9 | 8 | 81 |
| 15 | 20 | MP | . . . | 1000 | 31 | 17 | 9 | 8 | 81 |
| 15 | 20 | MP | . . . | 1000 | 31 | 17 | 9 | 8 | 22 |
| 15 | 20 | MP | . . . | 1000 | 31 | 17 | 9 | 8 | 37 |
| 15 | 20 | MP | . . . | 1000 | 31 | 17 | 9 | 8 | 31 |
| 15 | 20 | MP | . . . | 1000 | 31 | 17 | 9 | 8 | 74 |
| 20 | 20 | MP | . . . | 1000 | 30 | 20 | 9 | 11 | 13 |
| 20 | 20 | MP | . . . | 1000 | 30 | 20 | 9 | 11 | 76 |
| 20 | 20 | MP | . . . | 1000 | 30 | 20 | 9 | 11 | 43 |
| 15 | 5.5 | LP | 254 | 820 | 36 | 17 | 13 | 4 | 20.8 |
| 15 | 5.5 | LP | 254 | 820 | 36 | 17 | 13 | 4 | 13.6 |
| 15 | 5.5 | LP | 254 | 820 | 36 | 17 | 13 | 4 | 20.9 |
| 15 | 5.5 | LP | 254 | 820 | 36 | 17 | 13 | 4 | 20.3 |
| 30 | 5.5 | LP | 254 | 820 | 36 | 17 | 13 | 4 | 6.0 |
| 30 | 5.5 | LP | 254 | 820 | 36 | 17 | 13 | 4 | 27.5 |
| 30 | 5.5 | LP | 254 | 820 | 36 | 17 | 13 | 4 | 7.0 |
| 30 | 5.5 | LP | 254 | 820 | 36 | 17 | 13 | 4 | 19.3 |
| 30 | 5.5 | LP | 254 | 820 | 36 | 17 | 13 | 4 | 39.2 |
| 30 | 5.5 | LP | 254 | 820 | 36 | 17 | 13 | 4 | 11.7 |
| 30 | 5.5 | LP | 254 | 820 | 36 | 17 | 13 | 4 | 23.9 |
| 30 | 5.5 | LP | 254 | 820 | 36 | 17 | 13 | 4 | 7.1 |
| 30 | 5.5 | LP | 254 | 820 | 36 | 17 | 13 | 4 | 30.5 |
| 30 | 5.5 | LP | 254 | 820 | 36 | 17 | 13 | 4 | 6.1 |
| 30 | 5.5 | LP | 254 | 820 | 36 | 17 | 13 | 4 | 55.4 |
| 30 | 5.5 | LP | 254 | 820 | 36 | 17 | 13 | 4 | 6.6 |
| 30 | 5.5 | LP | 254 | 820 | 36 | 17 | 13 | 4 | 38.1 |
| 30 | 5.5 | LP | 254 | 820 | 36 | 17 | 13 | 4 | 29.5 |
| 30 | 5.5 | LP | 254 | 820 | 36 | 17 | 13 | 4 | 20.9 |
| 30 | 5.5 | LP | 254 | 820 | 36 | 17 | 13 | 4 | 19.3 |
| 5 | 5.5 | LP | 254 | 820 | 36 | 17 | 13 | 4 | 26.4 |
| 5 | 5.5 | LP | 254 | 820 | 36 | 17 | 13 | 4 | 18.8 |
| 5 | 5.5 | LP | 254 | 820 | 36 | 17 | 13 | 4 | 24.4 |
| 5 | 5.5 | LP | 254 | 820 | 36 | 17 | 13 | 4 | 17.8 |
| 10 | 5.5 | LP | 254 | 820 | 36 | 17 | 13 | 4 | 17.3 |
| 10 | 5.5 | LP | 254 | 820 | 36 | 16 | 11 | 5 | 19.3 |
| 10 | 5.5 | LP | 254 | 820 | 36 | 16 | 11 | 5 | 25.9 |
| 10 | 5.5 | LP | 254 | 820 | 36 | 16 | 11 | 5 | 9.1 |
| 10 | 5.5 | LP | 254 | 820 | 36 | 16 | 11 | 5 | 23.9 |
| 10 | 5.5 | LP | 254 | 820 | 36 | 16 | 11 | 5 | 27 |
| 10 | 5.5 | LP | 254 | 820 | 36 | 16 | 11 | 5 | 29 |
| 8 | 15.0 | LP | 254 | 820 | 36 | 16 | 12 | 4 | 9.2 |
| 8 | 15.0 | LP | 254 | 820 | 36 | 16 | 12 | 4 | 16.2 |
| 8 | 15.0 | LP | 254 | 820 | 36 | 16 | 12 | 4 | 40.2 |
| 8 | 15.0 | LP | 254 | 820 | 36 | 16 | 12 | 4 | 22.4 |
| 8 | 15.0 | LP | 254 | 820 | 36 | 16 | 12 | 4 | 31.5 |
| 8 | 15.0 | LP | 254 | 820 | 36 | 16 | 12 | 4 | 9.7 |
| 8 | 15.0 | LP | 254 | 820 | 36 | 16 | 12 | 4 | 15.8 |
| 8 | 15.0 | LP | 254 | 820 | 36 | 16 | 12 | 4 | 17.8 |
| 13 | 15.0 | LP | 254 | 820 | 36 | 16 | 12 | 4 | 36.6 |
| 13 | 15.0 | LP | 254 | 820 | 36 | 16 | 12 | 4 | 50.9 |
| 13 | 15.0 | LP | 254 | 820 | 36 | 16 | 12 | 4 | 13.7 |
| 13 | 15.0 | LP | 254 | 820 | 36 | 16 | 12 | 4 | 17.8 |
| 13 | 15.0 | LP | 254 | 820 | 36 | 16 | 12 | 4 | 24.4 |
| 13 | 15.0 | LP | 254 | 820 | 36 | 16 | 12 | 4 | 19.3 |
| 13 | 15.0 | LP | 254 | 820 | 36 | 16 | 12 | 4 | 21.4 |
| 5 | 5.5 | LP | 254 | 820 | 36 | 17 | 11 | 6 | 31.0 |
| 5 | 5.5 | LP | 254 | 820 | 36 | 17 | 11 | 6 | 24.9 |
| 5 | 5.5 | LP | 254 | 820 | 36 | 17 | 11 | 6 | 21.9 |
| 5 | 5.5 | LP | 254 | 820 | 36 | 17 | 11 | 6 | 16.3 |
| 5 | 5.5 | LP | 254 | 820 | 36 | 17 | 11 | 6 | 30.0 |
| 5 | 5.5 | LP | 254 | 820 | 36 | 17 | 11 | 6 | 20.3 |
| 5 | 5.5 | LP | 254 | 820 | 36 | 17 | 11 | 6 | 27.0 |
| 5 | 5.5 | LP | 254 | 820 | 36 | 17 | 11 | 6 | 18.3 |
| 5 | 5.5 | LP | 254 | 820 | 36 | 17 | 11 | 6 | 17.3 |
| 5 | 5.5 | LP | 254 | 820 | 36 | 17 | 11 | 6 | 29.5 |
| 5 | 5.5 | LP | 254 | 820 | 36 | 17 | 11 | 6 | 28.0 |
| 5 | 5.5 | LP | 254 | 820 | 36 | 17 | 11 | 6 | 27.5 |
| 10 | 5.5 | LP | 254 | 820 | 36 | 17 | 10 | 7 | 32.0 |
| 10 | 5.5 | LP | 254 | 820 | 36 | 17 | 10 | 7 | 10.7 |
| 10 | 5.5 | LP | 254 | 820 | 36 | 17 | 10 | 7 | 47.3 |
| 10 | 5.5 | LP | 254 | 820 | 36 | 17 | 10 | 7 | 15.3 |
| 10 | 5.5 | LP | 254 | 820 | 36 | 17 | 10 | 7 | 17.8 |
| 10 | 5.5 | LP | 254 | 820 | 36 | 17 | 10 | 7 | 28.5 |

TABLE 2

| | Static Bonding | | |
|---|---|---|---|
| | MOE | | Internal Bonding |
| | [MPa] | MOR [MPa] | [MPa] |
| Required minimum value | 3100 | 17.2 | 0.345 |
| Non-UV/ozone treated | <500 | <5 | <0.05 |
| UV/ozone treated panel 1 | 3800 | 24.1 | 0.381 |
| UV/ozone treated panel 1 | 3600 | 22.8 | 0.363 |

1. Process for the preparation of a panel comprising a ligno-cellulose containing strand-like material, comprising the following steps:
a) treating the ligno-cellulose containing strand-like material with a combination of UV-radiation and ozone, either in-situ or ex-situ
b) mixing the resulting product with an adhesive composition;
c) applying the resulting mix onto a press-bottom, and
d) pressing and at least partially curing the composition obtained in step c) to obtain a panel.

2. Process according to claim 1 wherein the adhesive composition is a water-based resin.

3. Process according to claim 2 wherein the water-based resin is selected from the group consisting of soybean, an aidehyde, and at least one component selected from the group consisting of urea, phenol and melamine, or mixtures thereof.

4. Process according to claim 3 wherein the aldehyde is formaldehyde

5. Process according to claim 1 wherein the adhesive composition is a non-water based resin.

6. Process according to claim 5 wherein the non-water based resin is selected from the group consisting of soybean polyvinyl acetates, epoxypolyester and acrylics.

7. Process according to claim 1, wherein the curing temperature is between 275 and 525 K.

8. Process according to claim 1, wherein the UV-radiation has a wavelength of between 1 and 385 nm, preferably below 310 nm, more preferable 254 nm.

9. Process according to claim 1, wherein the UV-radiation has an intensity of between 0.1 and 725 mW/cm² preferably between 1 and 60 mW/cm² even more preferably between 10 and 50 mW/cm²

10. Process according to claim 1, wherein the ligno-cellulose containing material is a non-wood agricultural material.

11. Process according to claim 1, wherein the ligno-cellulose containing material has a water content up to full saturation.

12. Process according to claim 1, wherein the ligno-cellulose containing material is natural straw.

13. Process according to claim 1, wherein the adhesive composition is used in an amount of between 1 and 30 wt %.

14. Process according to claim 1, wherein the adhesive composition is cured to at least 75%.

15. Process according to claim 1, wherein the ligno-cellulose containing material is in the form of strands, which have been oriented prior to step d).

16. Process according to claim 1, wherein the curing of the composition takes place at a temperature of between 350 and 450 K.

17. Process according to claim 1, wherein the adhesive composition comprises and aldehyde and melamine.

18. Process according to claim 17, wherein the aldehyde is formaldehyde.

19. Panel, obtainable by a process according to claim 1.

20. Panel according to claim 19, having the mechanical properties according to Canadian Standard CSA O437.0-93 Group 1 (R-1).

21. Oriented Strand Board, Medium Density Fiber Board, High Density Fiber Board, insulation board or Particle Board, obtainable by a process according to claim 1.

22. Apparatus suitable for performing a process according to claim 1.
